(19) United States
(12) Patent Application Publication
(10) Pub. No.: US 2026/0332955 A1
(43) Pub. Date: Oct. 22, 2026

(54) Microphone Coupling System with Integrated Magnetic Interface for Phase-Coincident Stereo Recording

(71) Applicant: Derek Bargaehr, Hatfield, PA (US)

(72) Inventor: Derek Bargaehr, Hatfield, PA (US)

(21) Appl. No.: 19/690,393

(22) Filed: May 28, 2026

Related U.S. Application Data
(60) Provisional application No. 63/766,480, filed on Mar. 4, 2025.

(51) Int. Cl. H04R 5/027; H04R 1/08; H04R 9/08

(52) U.S. Cl. CPC H04R 5/027; H04R 1/08; H04R 9/08; H04R 2201/025; H04R 2209/022

(57) ABSTRACT

A microphone coupling system comprises a first microphone body and a second microphone body, each having a transducer at a coupling end, and a magnetic coupling interface with components integrated within the coupling ends of both microphone bodies. The magnetic coupling interface magnetically couples the two microphone bodies in an end-to-end configuration without any external mounting accessory between them. In the coupled configuration, one microphone body is continuously rotatable through a full revolution about a common longitudinal axis relative to the other while the magnetic coupling remains engaged, and the two transducers are held in alignment for phase-coincident stereo capture. The system supports cross-brand and cross-type microphone pairing, tool-free engagement and disengagement, and extension to multi-microphone stacks for spatial audio capture.

### CROSS-REFERENCE TO RELATED APPLICATIONS

This application claims priority to U.S. Provisional Patent Application No. 63/______, filed [DATE], the entire contents of which are incorporated herein by reference.

### FIELD OF INVENTION

The present disclosure relates generally to apparatus for stereophonic audio recording with multiple microphones, and more particularly to a coupling system that releasably joins two or more independent studio microphones in an end-to-end configuration through a magnetic coupling interface.

### BACKGROUND

Stereophonic audio recording techniques in which two transducers capture the same acoustic source from differing angular vantage points to produce a left channel and a right channel are foundational to professional music recording, broadcast sound capture, and immersive audio production. Among such techniques, the family of phase-coincident techniques in which the two transducers are positioned at substantially the same point in space, and the stereo image is encoded entirely in the differing angular response of the two pickup patterns rather than in any time-of-arrival difference between the two transducers, is widely valued for the cleanliness with which the resulting stereo signal sums to mono. Achieving phase coincidence in practice requires the transducers to be positioned within a small fraction of an audio wavelength of one another, with their principal sensitive axes set to a desired angle and held there reliably during recording, and with sufficient mechanical access to the recording subject to permit the transducers to be placed at the optimal location relative to that subject.

The most basic apparatus for setting up a phase-coincident stereo pair employs two separate microphone stands, with each stand carrying a single microphone in a conventional clip mount, and the engineer manually positioning the two stands such that the two transducers approach a common point in space at the desired angle. This approach affords the engineer complete freedom of microphone selection and placement, but suffers from several practical drawbacks. Two stands consume more floor space than one and limit access to the recording subject by the performer, the engineer, and other equipment. Reproducing a particular angular configuration from one session to the next is difficult because the two stands must be independently positioned to within a small tolerance, and the two stands tend to drift relative to one another in response to incidental contact and cable dressing during the session. The two transducers cannot reliably be placed sufficiently close to one another to achieve true phase coincidence, because the two stand bases occupy floor space that prevents the stand columns from approaching closely, and the resulting recordings exhibit a degree of comb filtering that varies with the angle of incidence of each sound source.

A first refinement employs a stereo bar, a horizontal accessory mounted to the top of a single microphone stand and carrying two clip mounts at its ends, into which two independent microphones are clipped to form a stereo pair on a single stand. The stereo bar reduces the floor-space requirement and improves the reproducibility of the stereo configuration relative to two independent stands, but introduces its own limitations. Each stereo bar must be sized for particular microphone clips, and a bar suited to one pair of microphones is generally unsuitable for another pair of different size or weight. The mechanical structure of the bar itself sits in the audio path between the recording subject and the transducers, presenting a surface from which acoustic reflections may arrive at the transducers and produce coloration of the recorded signal. The angular range over which the two transducers can be set is limited by the geometry of the bar and the clips. A second refinement employs a dedicated stereo microphone, in which two transducers are integrated within a single shared housing on a single stand mount. Dedicated stereo microphones eliminate the need for any external mounting accessory and produce reproducible stereo configurations, but at the cost of fixing the transducer selection at the time of manufacture, increased complexity and expense relative to a pair of equivalent independent microphones, and a rotational range between the two transducers that is typically limited to less than a full revolution by the wiring connections passing through the rotating joint.

A separate line of development has produced magnetic mounting systems for individual microphones, in which a permanent magnet is incorporated into the microphone body or into a mounting accessory, and a corresponding ferromagnetic surface is provided on a stand, headset, vehicle interior, or other mounting target. These systems permit the user to attach and detach a single microphone to and from a single mounting target without tools, and in some implementations to rotate the microphone about a single axis between a discrete set of preferred angular positions defined by ramp surfaces or detents in the magnetic interface. The magnetic mounting concept has not, however, been extended to the coupling of two or more independent microphones to one another for stereo or spatial audio capture; the magnetic interfaces in such systems are designed exclusively to couple a microphone to a non-microphone surface, do not provide for continuous rotation through a full revolution, and do not address the geometric requirements of phase-coincident transducer placement.

There is accordingly a need in the art for a coupling system that combines the angular reproducibility and compactness of a dedicated stereo microphone with the freedom of microphone selection of a two-stand configuration, that permits two independent microphones to be coupled and decoupled by hand without tools or external mounting accessories, that holds the two transducers in deterministic alignment for phase-coincident stereo capture without imposing rotational limits, that accommodates the assembly of three or more microphones into multi-microphone arrays for spatial audio capture, and that does so independently of the manufacturer, transducer technology, or acoustic characteristics of the individual microphones.

It is within this context that the present invention is provided.

### SUMMARY OF INVENTION

According to a first aspect of the present disclosure, there is provided a microphone coupling system comprising a first microphone body and a second microphone body, each comprising a transducer at a coupling end thereof, and a magnetic coupling interface comprising at least one magnet and having components integrated within the coupling end of the first microphone body and within the coupling end of the second microphone body. The magnetic coupling interface is configured to magnetically couple the coupling end of the first microphone body to the coupling end of the second microphone body, without an external mounting accessory between the first microphone body and the second microphone body, in an end-to-end coupled configuration. In the end-to-end coupled configuration, the first microphone body is rotatable continuously through a full revolution about a common longitudinal axis relative to the second microphone body while the magnetic coupling interface remains engaged, and the transducer of the first microphone body and the transducer of the second microphone body are positioned in alignment for phase-coincident stereo capture.

In some embodiments, the first microphone body and the second microphone body are configured to be magnetically coupled by the magnetic coupling interface independently of differences in transducer type, manufacturer, or acoustic characteristics between the first microphone body and the second microphone body.

In some embodiments, at least one of the first microphone body and the second microphone body further comprises a further magnetic coupling interface at an end thereof opposite the coupling end, the further magnetic coupling interface configured to magnetically couple to a coupling end of a further microphone body in a further end-to-end coupled configuration. In some embodiments, the system further comprises one or more further microphone bodies each magnetically coupled to a preceding microphone body in the system, the first microphone body, the second microphone body, and the one or more further microphone bodies forming a stack aligned along the common longitudinal axis for spatial audio capture.

In some embodiments, the at least one magnet is of substantially annular form and is concentric with the common longitudinal axis when the system is in the end-to-end coupled configuration. In some embodiments, the at least one magnet comprises a material selected from the group consisting of neodymium-iron-boron, samarium-cobalt, alnico, and ferrite. In some embodiments, the at least one magnet comprises a Halbach arrangement of magnetic segments configured to concentrate magnetic flux toward the coupling ends of the first microphone body and the second microphone body and to substantially cancel magnetic flux on a side of the at least one magnet facing away from the coupling ends.

In some embodiments, the at least one magnet comprises a discrete magnet component captured between a first ferromagnetic surface integrated within the coupling end of the first microphone body and a second ferromagnetic surface integrated within the coupling end of the second microphone body. In some embodiments, the at least one magnet is affixed to the coupling end of the first microphone body, and the magnetic coupling interface further comprises a ferromagnetic surface integrated within the coupling end of the second microphone body.

In some embodiments, the magnetic coupling interface is electrically isolating, the magnetic coupling interface transmitting no electrical signal between the first microphone body and the second microphone body. In some embodiments, the first microphone body and the second microphone body are operable to be engaged into and disengaged from the end-to-end coupled configuration manually without the use of tools or additional fasteners.

In some embodiments, the magnetic coupling interface further comprises one or more flux-concentration features configured to produce a discrete plurality of preferred angular positions during rotation of the first microphone body relative to the second microphone body, the preferred angular positions providing tactile detents without preventing continuous rotation between the preferred angular positions. In some embodiments, at least one of the transducer of the first microphone body and the transducer of the second microphone body is a ribbon transducer, and the magnetic coupling interface further comprises a shielding element disposed between the at least one magnet and the ribbon transducer, the shielding element configured to attenuate magnetic flux from the at least one magnet at the ribbon transducer.

According to a second aspect of the present disclosure, there is provided a method of phase-coincident stereo recording, the method comprising providing a first microphone body and a second microphone body, each having a magnetic coupling interface integrated within a coupling end thereof and a transducer disposed at the coupling end; magnetically engaging the coupling end of the first microphone body with the coupling end of the second microphone body, without an external mounting accessory between the first microphone body and the second microphone body, to form an end-to-end coupled configuration in which the transducer of the first microphone body and the transducer of the second microphone body are positioned in alignment for phase-coincident stereo capture; rotating the first microphone body relative to the second microphone body about a common longitudinal axis to set an angle between a principal sensitive axis of the transducer of the first microphone body and a principal sensitive axis of the transducer of the second microphone body; and recording a stereo audio signal via independent audio outputs of the first microphone body and the second microphone body.

In some embodiments, the first microphone body and the second microphone body differ in at least one of transducer type, manufacturer, and acoustic characteristics. In some embodiments, rotating the first microphone body relative to the second microphone body comprises rotating the first microphone body to set the angle to one of zero degrees, ninety degrees corresponding to a Blumlein crossed-figure-of-eight configuration, one hundred and ten degrees, and one hundred and eighty degrees.

In some embodiments, the method further comprises mounting the first microphone body and the second microphone body, in the end-to-end coupled configuration, on a single microphone stand utilizing a thread or clip on one of the first microphone body and the second microphone body. In some embodiments, the method further comprises magnetically engaging a coupling end of a further microphone body with a further magnetic coupling interface at an end of one of the first microphone body and the second microphone body opposite the coupling end thereof, to form a stack of three or more microphone bodies for spatial audio capture.

In some embodiments, magnetically engaging the coupling end of the first microphone body with the coupling end of the second microphone body is performed manually without the use of tools or additional fasteners. In some embodiments, the method further comprises, after recording the stereo audio signal, manually separating the first microphone body from the second microphone body for independent monophonic use of the first microphone body and the second microphone body.

### BRIEF DESCRIPTION OF THE DRAWINGS

Various embodiments of the invention are disclosed in the following detailed description and accompanying drawings.

FIG. 1 illustrates a schematic representation of a phase-coincident stereophonic recording arrangement that the magnetic microphone coupling system disclosed herein is configured to enable, according to an embodiment of the present disclosure.

FIG. 2A illustrates an exploded view of a magnetic microphone coupling system showing two microphone bodies, the transducers carried within them, the ferromagnetic surfaces at their coupling ends, and a discrete magnet captured between the ferromagnetic surfaces, according to an embodiment of the present disclosure.

FIG. 2B illustrates an assembled view of the magnetic microphone coupling system of FIG. 2A in an end-to-end coupled configuration, with rotation of one microphone body relative to the other indicated, according to an embodiment of the present disclosure.

Common reference numerals are used throughout the figures and the detailed description to indicate like elements. One skilled in the art will readily recognize that the above figures are examples and that other configurations, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

As used herein, the following terms have the meanings set forth below unless the context clearly dictates otherwise. These definitions are provided to aid in the understanding of the specification and claims and are not intended to limit the scope of the invention beyond what is required by the claims themselves.

The term “phase-coincident stereo capture” refers to a mode of stereophonic audio recording in which two transducers are positioned at substantially the same point in space, such that sound pressure waves from any external source arrive at both transducers at substantially the same instant in time, and the resulting stereo image is encoded entirely in the differing angular response of the two transducers'pickup patterns rather than in any time-of-arrival difference between the transducers. Phase-coincident stereo capture encompasses configurations including, without limitation, the Blumlein crossed-figure-of-eight configuration, the XY coincident pair, the mid-side configuration, and any other coincident or near-coincident configuration in which the two transducers are within a small fraction of an audio wavelength of one another.

The term “transducer” refers to the active element of a microphone that converts incident sound pressure waves into a corresponding electrical signal, including without limitation a ribbon transducer in which a corrugated metallic ribbon is suspended in a permanent magnetic field, a condenser transducer in which a thin diaphragm forms one plate of a capacitor, and a moving-coil dynamic transducer in which a coil affixed to a diaphragm moves within a permanent magnetic field. The transducer is distinguished from the housing or body of the microphone in which it is mounted, and from any associated preamplification, impedance matching, or output circuitry.

The term “principal sensitive axis,” as applied to a transducer, refers to the direction in space along which the transducer exhibits its maximum response to incident sound pressure waves. For a figure-of-eight (bidirectional) transducer the principal sensitive axis is the line passing perpendicular to the plane of the diaphragm or ribbon; for a cardioid transducer the principal sensitive axis is the line of maximum on-axis sensitivity; and corresponding definitions apply for other directional patterns. The angle between the principal sensitive axes of two transducers determines the character of the stereo image produced by a coincident or near-coincident pair.

The term “microphone body” refers to the housing structure that supports a transducer, encloses any associated electronic circuitry, and provides external mechanical features for mounting and connection. As used herein, the microphone body is a discrete physical object distinct from any external mounting accessory such as a shockmount, stereo bar, or stand bracket; magnetic interface elements described herein as “integrated within” the microphone body are part of the microphone body itself rather than part of any separate accessory.

The term “coupling end,” as applied to a microphone body, refers to the longitudinal end of the microphone body at which the magnetic coupling interface is located. In embodiments in which the microphone body has a magnetic coupling interface at only one end, the coupling end is that end; in embodiments in which the microphone body has a magnetic coupling interface at both ends, both ends are coupling ends and may be distinguished as a first coupling end and a second coupling end.

The term “magnetic coupling interface” refers to the cooperating arrangement of magnets, ferromagnetic surfaces, and any associated structural features at the coupling ends of two microphone bodies that, when the two coupling ends are presented end-to-end, produces a magnetic holding force sufficient to retain the two microphone bodies in an end-to-end coupled configuration. The magnetic coupling interface is a passive mechanical and magnetic feature; it does not include any electrical connection between the two microphone bodies.

The term “ferromagnetic surface” refers to a region of low-reluctance ferromagnetic material, such as low-carbon steel, soft iron, or a comparable alloy, configured to provide a magnetic flux return path for a cooperating magnet. The ferromagnetic surface need not itself be magnetized; its function is to complete the magnetic circuit of the magnet to which it cooperates and thereby produce a holding force between the two microphone bodies.

The term “Blumlein crossed-figure-of-eight configuration” refers to the stereo recording configuration in which two bidirectional transducers are positioned in phase-coincident proximity with their principal sensitive axes set at right angles to one another, such that the four lobes of the two figure-of-eight pickup patterns occupy the four quadrants of the horizontal plane and the resulting stereo image faithfully preserves both direct and ambient sound from the recording environment.

The term “spatial audio capture” refers to a mode of audio recording in which three or more transducers are arranged in a defined geometric relationship to capture the sound field in two or three dimensions, including without limitation first-order ambisonic capture, double mid-side recording, quadraphonic recording, and higher-order configurations.

Unless expressly stated otherwise, words such as “a,” “an,” and “the” are intended to include both singular and plural forms, and the term “about” is intended to accommodate ±10 % variations in stated values. Recitation of a range inherently includes all sub-ranges and individual values within that range. All exemplary materials, dimensions, and values may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

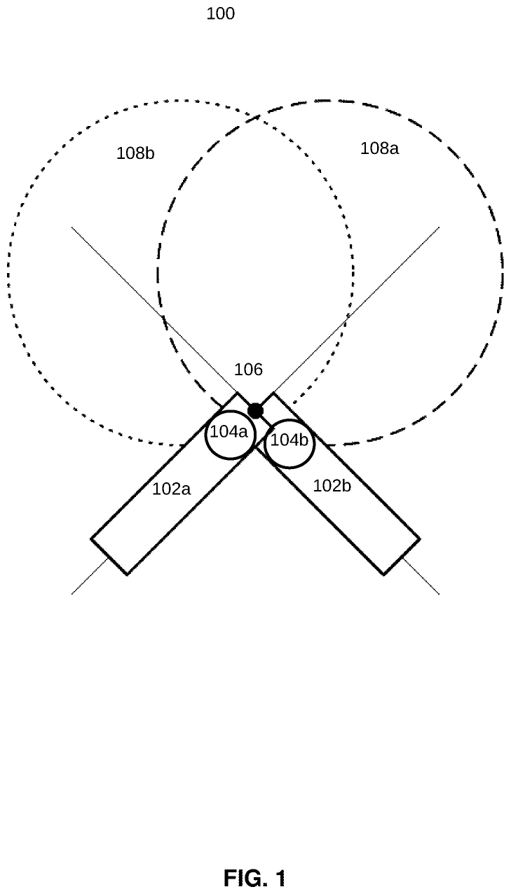

Referring now to FIG. 1, a phase-coincident stereo recording arrangement 100 that the magnetic microphone coupling system disclosed herein is configured to enable in practical use is shown in schematic form according to an embodiment of the present disclosure. The phase-coincident stereo recording arrangement 100 comprises a first microphone body 102a and a second microphone body 102b, each carrying a respective transducer 104a, 104b. The two microphone bodies 102a, 102b are positioned such that their long axes cross at an angle, with the transducers 104a, 104b brought into close proximity at a transducer coincidence point 106. Each transducer 104a, 104b has an associated pickup pattern 108a, 108b, drawn in FIG. 1 as a figure-of-eight lobe oriented substantially perpendicular to the long axis of the corresponding microphone body 102a, 102b, although the principles described herein apply equally to other directional patterns including cardioid, hypercardioid, supercardioid, and omnidirectional patterns.

The transducer coincidence point 106 is the location at which the two transducers 104a, 104b are notionally co-located. When the two transducers 104a, 104b are sufficiently close to one another at the transducer coincidence point 106, sound pressure waves arriving at the phase-coincident stereo recording arrangement 100 from any external source reach both transducers 104a, 104b at substantially the same instant in time, regardless of the angle of incidence of the sound. Phase-coincident capture of the two channels is accordingly achieved, and the destructive and constructive frequency-dependent interference (commonly referred to as “comb filtering”) that would otherwise corrupt the recording when the same source is captured by two non-coincident transducers and the resulting channels are subsequently summed to mono or panned within a stereo image is substantially avoided.

The angle subtended between the two long axes of the microphone bodies 102a, 102b in FIG. 1, and consequently the angle between the principal sensitive axes of the two transducers 104a, 104b normal to those long axes, determines the character of the resulting stereo image. When the two pickup patterns 108a, 108b are figure-of-eight in shape and the angle between the long axes is set to ninety degrees, the phase-coincident stereo recording arrangement 100 corresponds to a Blumlein crossed-figure-of-eight configuration, producing a wide and naturalistic stereo image that captures both direct and ambient sound from the recording environment. Other angles, and other directional patterns, give rise to further coincident or near-coincident stereo configurations including the XY pair, the mid-side configuration, and various intermediate configurations selected by the recording engineer to suit the source material and the recording environment.

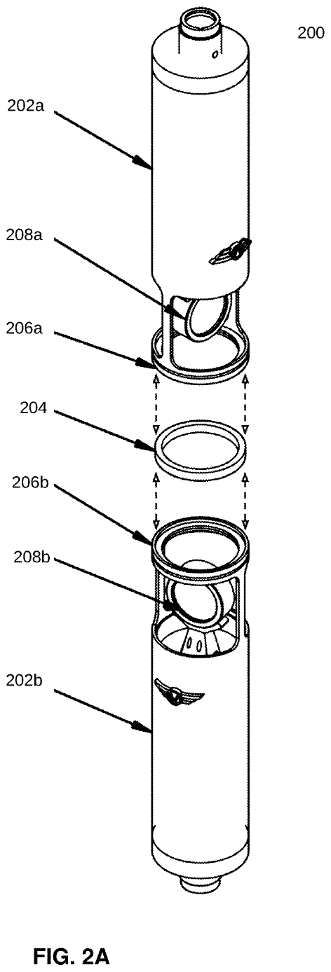

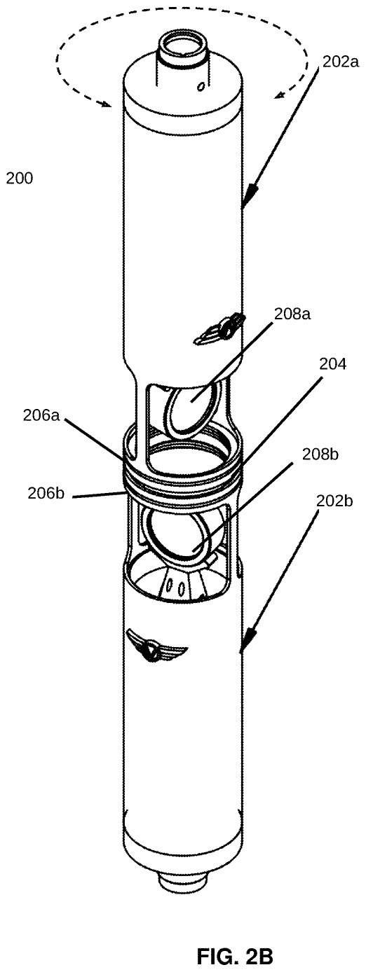

Referring now to FIG. 2A, an exploded view of a magnetic microphone coupling system 200 is shown according to an embodiment of the present disclosure. The magnetic microphone coupling system 200 comprises a first microphone body 202a and a second microphone body 202b. Each of the microphone bodies 202a, 202b is a generally elongated, substantially cylindrical housing terminating, at a coupling end, in an open frame structure that exposes a corresponding transducer 208a, 208b through one or more lateral apertures while protecting the transducer 208a, 208b from physical contact and, in the case of pressure-gradient transducers, from incidental airflow over the rear of the transducer element. Each transducer 208a, 208b is mounted within the open frame structure with a principal sensitive axis oriented substantially perpendicular to the long axis of the corresponding microphone body 202a, 202b. At the longitudinal end of each microphone body 202a, 202b opposite the coupling end, an audio output connector (such as an XLR connector) is provided through which the audio signal generated by the corresponding transducer 208a, 208b is conveyed to recording equipment independently of the other microphone body in the magnetic microphone coupling system 200.

At the longitudinal extremity of the open frame structure, immediately adjacent the transducer mounting, each microphone body 202a, 202b terminates in a ferromagnetic surface 206a, 206b. In the embodiment of FIG. 2A, the ferromagnetic surfaces 206a, 206b are of generally annular form and are concentric with the long axis of the corresponding microphone body 202a, 202b. The ferromagnetic surfaces 206a, 206b are formed of, or include, a low-reluctance ferromagnetic material such as low-carbon steel, soft iron, or a comparable alloy, and are dimensioned to provide a magnetic flux return path of sufficient permeance to support the holding force generated by a magnet 204 described below.

Between the coupling ends of the two microphone bodies 202a, 202b is provided the magnet 204. In the embodiment of FIG. 2A, the magnet 204 is of generally annular form and is concentric, in use, with the long axes of the two microphone bodies 202a, 202b. The magnet 204 is dimensioned and magnetized such that, when the two microphone bodies 202a, 202b are presented end-to-end with the magnet 204 captured between the two ferromagnetic surfaces 206a, 206b, magnetic flux passes from one pole of the magnet 204 through the ferromagnetic surface 206a, returns through the ferromagnetic surface 206b, and re-enters the magnet 204 at the opposite pole, generating an axial holding force between the two microphone bodies 202a, 202b sufficient to support the combined weight of the two microphone bodies 202a, 202b against gravity in any orientation in which the magnetic microphone coupling system 200 may foreseeably be used.

In an alternative embodiment, the magnet 204 is permanently affixed to (or formed integrally with) the coupling end of one of the two microphone bodies 202a, 202b, and the ferromagnetic surface 206a or 206b on the other microphone body engages with the so-affixed magnet directly, with no discrete magnet component. In a further alternative embodiment, both microphone bodies 202a, 202b carry magnets at their coupling ends, with the magnets on the two bodies polarized so as to attract one another when presented end-to-end. To prevent the user from inadvertently presenting the bodies in a repulsion orientation in this further alternative embodiment, the coupling ends of the two microphone bodies 202a, 202b may be provided with complementary keying features (such as a step or notch in one and a corresponding projection in the other) that constrain assembly to the correct orientation while preserving the rotational freedom about the longitudinal axis described in further detail with reference to FIG. 2B.

The magnet 204 (whether provided as a discrete component, affixed to one microphone body 202a or 202b, or distributed across both microphone bodies 202a, 202b) may be formed of any of a range of permanent magnet materials. By way of example and not limitation, suitable materials include sintered neodymium-iron-boron (NdFeB), where high holding force per unit volume is desired; samarium-cobalt (SmCo), where elevated thermal stability and corrosion resistance are desired; alnico, where a more traditional magnetic material is preferred; and ferrite (ceramic) materials, where lower stray magnetic field and lower cost are preferred at the expense of holding force per unit volume.

The magnet 204 may further be configured in any of a range of geometries to suit the requirements of a particular application. In addition to the single annular ring shown in FIG. 2A, the magnet 204 may be implemented as a circular array of discrete cylindrical or arc-segment magnets distributed about the longitudinal axis with consistent or alternating polarities; as a diametrically magnetized ring; or as a Halbach arrangement of magnetic segments configured to concentrate the magnetic flux on the side of the magnet 204 facing the ferromagnetic surfaces 206a, 206b and to substantially cancel the magnetic flux on the side of the magnet 204 facing away from the ferromagnetic surfaces 206a, 206b. The Halbach arrangement is of particular utility where the transducers 208a, 208b are of the moving-coil dynamic or ribbon type and incorporate permanent magnets of their own, since the substantial cancellation of stray field on the transducer-facing side of the magnet 204 reduces the risk of the coupling field perturbing the transducer's own magnetic circuit.

Considerations of magnetic shielding more generally are addressed in further embodiments by the inclusion, between the magnet 204 and each transducer 208a, 208b, of a flux-return geometry or shielding element configured to confine the magnetic field of the magnet 204 to the immediate vicinity of the coupling interface. The ferromagnetic surfaces 206a, 206b themselves contribute to this confinement, and may be extended in the longitudinal direction toward the corresponding transducer 208a, 208b to form a cup-core-type structure that further reduces the stray field reaching the transducer 208a, 208b. In ribbon-type embodiments, an additional ring of mu-metal or comparable high-permeability shielding material may be interposed between the ferromagnetic surface 206a, 206b and the ribbon motor of the transducer 208a, 208b to prevent the coupling field from interacting with the ribbon motor's permanent magnets and degrading the linearity of the ribbon transducer.

The transducers 208a, 208b are not limited to any particular transducing technology. In one embodiment, the transducers 208a, 208b are ribbon transducers, in which a thin corrugated metallic ribbon is suspended in the magnetic field of one or more permanent magnets, the audio signal being induced in the ribbon by its motion in response to incident sound pressure waves. In another embodiment, the transducers 208a, 208b are condenser transducers, in which a thin diaphragm forms one plate of a capacitor and the audio signal is derived from variations in the capacitance produced by motion of the diaphragm in response to incident sound pressure waves. In a further embodiment, the transducers 208a, 208b are moving-coil dynamic transducers, in which a coil affixed to a diaphragm moves within the field of a permanent magnet to induce the audio signal. The two transducers 208a, 208b within a given coupled assembly need not be of the same type: a ribbon transducer 208a may be coupled to a condenser transducer 208b, or any other combination, provided each is housed in a microphone body 202a or 202b incorporating the magnetic coupling interface described herein.

The magnetic coupling interface, comprising in cooperation the magnet 204 and the two ferromagnetic surfaces 206a, 206b, is in this respect a passive mechanical and magnetic feature that admits of standardization independently of the transducer technology, the manufacturer, the housing material, or any other characteristic of the host microphone body 202a, 202b. Two microphone bodies 202a, 202b from different manufacturers, of different transducer types, and of different acoustic characteristics can accordingly be coupled and used together as a stereo pair by the magnetic microphone coupling system 200, provided each is constructed with the magnetic coupling interface to a common dimensional and magnetic specification. The user is thereby afforded freedom to assemble unconventional stereo pairs for creative purposes—for example, pairing a darker-sounding ribbon microphone with a brighter condenser microphone to achieve a specific spectral balance—that is not available with proprietary integrated stereo microphones in which the transducer selection is fixed at manufacture.

In further embodiments, the magnetic coupling interface is provided not at one end only of each microphone body 202a, 202b but at both ends. In such an embodiment, a microphone body has a first magnetic coupling interface at its first end and a second magnetic coupling interface at its second end, each of the form described above. Such a microphone body can accordingly be coupled at one end to a first further microphone body and at its other end to a second further microphone body, forming a stack of three or more coupled microphone bodies aligned along a common longitudinal axis. The microphone body or bodies in the interior of such a stack are configured, in this embodiment, to accept incident sound through the lateral apertures of their open frame structures at both ends, and to be electrically and acoustically transparent along their longitudinal extent—in practice, by terminating each transducer's audio output connector laterally rather than longitudinally and by appropriate routing of internal wiring within the corresponding microphone body. Three-microphone, four-microphone, and higher-order stacks of this kind support a range of spatial audio recording configurations including double mid-side recording, first-order ambisonic capture, quadraphonic recording, and higher-order spatial audio capture geometries.

Referring now to FIG. 2B, an assembled view of the magnetic microphone coupling system 200 in an end-to-end coupled configuration is shown according to an embodiment of the present disclosure. In FIG. 2B, the two microphone bodies 202a, 202b are joined end-to-end with the magnet 204 captured between the two ferromagnetic surfaces 206a, 206b at the magnetic coupling interface. The two transducers 208a, 208b are positioned one above the other at the magnetic coupling interface, separated only by the longitudinal extent of the magnet 204 and the immediately adjacent portions of the open frame structures. Because this longitudinal separation is small (typically of the order of one to several centimeters in a representative implementation, depending on the dimensions of the magnet 204 and the open frame structures), and is in any event substantially less than the wavelength of even the highest audio frequencies of interest, the two transducers 208a, 208b are positioned sufficiently close to one another to function as a phase-coincident stereo pair in the manner described above with reference to FIG. 1. The transducers 208a, 208b accordingly serve, in operation, as the first and second transducers 104a, 104b of the phase-coincident stereo recording arrangement 100, with their effective coincidence point corresponding to the transducer coincidence point 106.

The annular geometry of the magnet 204 and of the two ferromagnetic surfaces 206a, 206b, all three of which are concentric with a common longitudinal axis when assembled, performs a transducer alignment function in addition to the magnetic holding function. Because the magnetic energy of the magnetic microphone coupling system 200 is minimized when the magnet 204 and the two ferromagnetic surfaces 206a, 206b are coaxially aligned, the magnetic coupling itself acts to draw the two microphone bodies 202a, 202b into coaxial alignment as they are brought together, and to maintain that coaxial alignment thereafter against modest off-axis disturbances. The two transducers 208a, 208b, each fixed in known position relative to its respective microphone body 202a, 202b, are accordingly held in deterministic radial and longitudinal positions relative to one another whenever the magnetic microphone coupling system 200 is in its assembled state, ensuring that the geometric conditions for phase-coincident stereo capture described above with reference to FIG. 1 are reliably reproduced from one use to the next without manual alignment adjustment by the user.

FIG. 2B further indicates, by means of a curved arrow about the longitudinal axis of the assembled magnetic microphone coupling system 200, that one of the two microphone bodies 202a, 202b can be rotated relative to the other about the common longitudinal axis while the magnetic coupling between them is maintained. The rotation is unrestricted: because the magnet 204 and the two ferromagnetic surfaces 206a, 206b are each of substantially annular form and are concentric with the longitudinal axis, the magnetic field distribution at the magnetic coupling interface is rotationally symmetric to a high degree, and there is no rotational position at which the magnetic holding force is appreciably weaker or stronger than at any other rotational position. Because no electrical signals are transferred across the magnetic coupling interface, each microphone body 202a, 202b being wired through to the recording equipment independently of the other via its own audio output connector, there are no slip-ring or wire-flex limitations on the rotational range. One of the two microphone bodies 202a, 202b can accordingly be rotated relative to the other through a full revolution and beyond, in either direction, without disengagement of the magnetic coupling and without degradation of any electrical or mechanical function of the magnetic microphone coupling system 200.

The angular position of one microphone body 202a, 202b relative to the other directly determines the angle subtended between the principal sensitive axes of the two transducers 208a, 208b. The user is accordingly able to set this angle to any value desired, including (without limitation) zero degrees with the two transducers facing in the same direction, ninety degrees corresponding to the Blumlein crossed-figure-of-eight configuration when the transducers 208a, 208b are bidirectional, one hundred and ten degrees approximating the angle of the ORTF technique when the transducers 208a, 208b are cardioid, one hundred and eighty degrees with the two transducers facing in opposite directions, and any intermediate or further angle through to and beyond a full revolution.

Several optional features may be incorporated into the magnetic coupling interface to provide additional convenience to the user without altering the underlying mode of operation of the magnetic microphone coupling system 200. In one such embodiment, the magnetic field at the magnetic coupling interface is locally modulated, by means of shaped flux-concentration features on one or both of the ferromagnetic surfaces 206a, 206b, so as to produce a discrete plurality of preferred angular positions during rotation. The preferred angular positions correspond to common stereo angles such as zero, forty-five, ninety, one hundred and ten, one hundred and thirty-five, and one hundred and eighty degrees, providing the user with tactile detents at these positions while still permitting continuous rotation through any other angle when moderate rotational torque is applied. In another such embodiment, an external alignment indicator—for example, a printed mark, scribed line, or molded protrusion on the exterior of each microphone body 202a, 202b—permits the user to read the current angle between the two transducers 208a, 208b without disturbing the configuration. In a further such embodiment, a non-magnetic spacer ring of defined longitudinal thickness is interposed between the two ferromagnetic surfaces 206a, 206b in addition to the magnet 204, providing a controlled increase in the longitudinal separation of the two transducers 208a, 208b that may be desired for non-coincident stereo configurations such as the spaced-pair (AB) technique while preserving the cross-brand compatibility, free rotation, and tool-free engagement of the magnetic microphone coupling system 200.

In use, the two microphone bodies 202a, 202b are presented end-to-end and the magnetic coupling draws them into engagement without the application of any tools, fasteners, or external mounting hardware. The coupled assembly is then mounted on a single conventional microphone stand by means of the existing thread or clip on one of the two microphone bodies 202a, 202b, halving the floor-space requirement of the equivalent two-stand configuration and dispensing with the need for a stereo bar. The user rotates one microphone body 202a or 202b relative to the other about the longitudinal axis to set the desired angle between the two pickup patterns 108a, 108b, and the magnetic coupling holds that angular position passively against the moderate disturbances encountered in studio use, including incidental contact, cable dressing, and stand vibration. On completion of recording, the two microphone bodies 202a, 202b can be separated by hand and used independently as monophonic microphones, or paired with different counterparts to form different stereo configurations, without tools, recalibration, or accessory changes.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A microphone coupling system comprising:
a first microphone body and a second microphone body, each comprising a transducer at a coupling end thereof; and
a magnetic coupling interface comprising at least one magnet, the magnetic coupling interface having components integrated within the coupling end of the first microphone body and within the coupling end of the second microphone body, and the magnetic coupling interface being configured to magnetically couple the coupling end of the first microphone body to the coupling end of the second microphone body, without an external mounting accessory between the first microphone body and the second microphone body, in an end-to-end coupled configuration;
wherein in the end-to-end coupled configuration the first microphone body is rotatable continuously through a full revolution about a common longitudinal axis relative to the second microphone body while the magnetic coupling interface remains engaged, and the transducer of the first microphone body and the transducer of the second microphone body are positioned in alignment for phase-coincident stereo capture.

2. The system of claim 1, wherein the first microphone body and the second microphone body are configured to be magnetically coupled by the magnetic coupling interface independently of differences in transducer type, manufacturer, or acoustic characteristics between the first microphone body and the second microphone body.

3. The system of claim 1, wherein at least one of the first microphone body and the second microphone body further comprises a further magnetic coupling interface at an end thereof opposite the coupling end, the further magnetic coupling interface configured to magnetically couple to a coupling end of a further microphone body in a further end-to-end coupled configuration.

4. The system of claim 3, further comprising one or more further microphone bodies each magnetically coupled to a preceding microphone body in the system, the first microphone body, the second microphone body, and the one or more further microphone bodies forming a stack aligned along the common longitudinal axis for spatial audio capture.

5. The system of claim 1, wherein the at least one magnet is of substantially annular form and is concentric with the common longitudinal axis when the system is in the end-to-end coupled configuration.

6. The system of claim 1, wherein the at least one magnet comprises a material selected from the group consisting of neodymium-iron-boron, samarium-cobalt, alnico, and ferrite.

7. The system of claim 1, wherein the at least one magnet comprises a Halbach arrangement of magnetic segments configured to concentrate magnetic flux toward the coupling ends of the first microphone body and the second microphone body and to substantially cancel magnetic flux on a side of the at least one magnet facing away from the coupling ends.

8. The system of claim 1, wherein the at least one magnet comprises a discrete magnet component captured between a first ferromagnetic surface integrated within the coupling end of the first microphone body and a second ferromagnetic surface integrated within the coupling end of the second microphone body.

9. The system of claim 1, wherein the at least one magnet is affixed to the coupling end of the first microphone body, and the magnetic coupling interface further comprises a ferromagnetic surface integrated within the coupling end of the second microphone body.

10. The system of claim 1, wherein the magnetic coupling interface is electrically isolating, the magnetic coupling interface transmitting no electrical signal between the first microphone body and the second microphone body.

11. The system of claim 1, wherein the first microphone body and the second microphone body are operable to be engaged into and disengaged from the end-to-end coupled configuration manually without the use of tools or additional fasteners.

12. The system of claim 1, wherein the magnetic coupling interface further comprises one or more flux-concentration features configured to produce a discrete plurality of preferred angular positions during rotation of the first microphone body relative to the second microphone body, the preferred angular positions providing tactile detents without preventing continuous rotation between the preferred angular positions.

13. The system of claim 1, wherein at least one of the transducer of the first microphone body and the transducer of the second microphone body is a ribbon transducer, and the magnetic coupling interface further comprises a shielding element disposed between the at least one magnet and the ribbon transducer, the shielding element configured to attenuate magnetic flux from the at least one magnet at the ribbon transducer.

14. A method of phase-coincident stereo recording, the method comprising:
providing a first microphone body and a second microphone body, each having a magnetic coupling interface integrated within a coupling end thereof and a transducer disposed at the coupling end;
magnetically engaging the coupling end of the first microphone body with the coupling end of the second microphone body, without an external mounting accessory between the first microphone body and the second microphone body, to form an end-to-end coupled configuration in which the transducer of the first microphone body and the transducer of the second microphone body are positioned in alignment for phase-coincident stereo capture;
rotating the first microphone body relative to the second microphone body about a common longitudinal axis to set an angle between a principal sensitive axis of the transducer of the first microphone body and a principal sensitive axis of the transducer of the second microphone body; and
recording a stereo audio signal via independent audio outputs of the first microphone body and the second microphone body.

15. The method of claim 14, wherein the first microphone body and the second microphone body differ in at least one of transducer type, manufacturer, and acoustic characteristics.

16. The method of claim 14, wherein rotating the first microphone body relative to the second microphone body comprises rotating the first microphone body to set the angle to one of zero degrees, ninety degrees corresponding to a Blumlein crossed-figure-of-eight configuration, one hundred and ten degrees, and one hundred and eighty degrees.

17. The method of claim 14, further comprising mounting the first microphone body and the second microphone body, in the end-to-end coupled configuration, on a single microphone stand utilizing a thread or clip on one of the first microphone body and the second microphone body.

18. The method of claim 14, further comprising magnetically engaging a coupling end of a further microphone body with a further magnetic coupling interface at an end of one of the first microphone body and the second microphone body opposite the coupling end thereof, to form a stack of three or more microphone bodies for spatial audio capture.

19. The method of claim 14, wherein magnetically engaging the coupling end of the first microphone body with the coupling end of the second microphone body is performed manually without the use of tools or additional fasteners.

20. The method of claim 14, further comprising, after recording the stereo audio signal, manually separating the first microphone body from the second microphone body for independent monophonic use of the first microphone body and the second microphone body.
